(19) United States
(12) Patent Application Publication
(10) Pub. No.: US 2021/0362712 A1
(43) Pub. Date: Nov. 25, 2021

(54) METHOD AND DEVICE FOR INFLUENCING OR DEACTIVATING A CRUISE CONTROL SYSTEM

(71) Applicant: Robert Bosch GmbH, Stuttgart (DE)

(72) Inventors: Mathieu Grelaud, Ludwigsburg (DE); Michael Schoenherr, Renningen-Malmsheim (DE)

(21) Appl. No.: 16/629,092

(22) PCT Filed: May 9, 2018
(86) PCT No.: PCT/EP2018/062072

§ 371 Date: Jan. 7, 2020

(30) Foreign Application Priority Data
Jul. 12, 2017 (DE) 10 2017 211 886.5

(51) Int. Cl. B60W 30/14; B60W 30/16; B60W 40/105; B60W 50/16

(52) U.S. Cl. CPC B60W 30/143; B60W 30/16; B60W 2050/143; B60W 50/16; B60W 40/105

(57) ABSTRACT

A method for influencing and/or deactivating a cruise control system of a single-track motor vehicle, in which, after the activation of the method by the driver, the speed of a second motor vehicle traveling directly ahead is ascertained, the speed of the preceding motor vehicle is adopted by the motor vehicle, and a driver warning regarding the deactivation of the cruise control system, which has taken place or is impending, taking place with the aid of a haptic signal and the cruise control system being deactivated if a predefined minimum speed is undershot.

### BACKGROUND INFORMATION

German Patent Application No. DE 103 30 255 A1 describes a driver assistance method and a driver assistance device for a motor vehicle. In order to avoid a conflict, also at low speeds, between a parking assistance operating mode, which is activatable if a minimum speed is undershot, and in which distances to other objects are ascertained and control signals for at least one actuator of the vehicle and/or display signals are output, and an adaptive cruise control operating mode, which may be carried out up to the point of a vehicle standstill, and in which distances and relative speeds to other traveling vehicles are ascertained and control signals are output to actuators of the vehicle, it is provided that a state signal displaying a state of the adaptive cruise control operating mode is utilized for the parking assistance operating mode.

### SUMMARY

The present invention relates to a method for influencing or deactivating a cruise control system of a single-track motor vehicle, in which,
after the activation of the method by the driver, the speed of a second motor vehicle traveling directly ahead is ascertained,
the speed of the preceding motor vehicle is adopted by the motor vehicle and,
a driver warning or a driver alert regarding the deactivation of the cruise control system, which has taken place or is impending, taking place with the aid of a haptic signal and the cruise control system being deactivated if a predefined minimum speed is undershot.

As a result, an unstable driving condition due to a driver-independent adjustment of a speed, which is too slow, is avoided and the driver is simultaneously made aware of the fact that he/she must now take over the full control of the vehicle speed.

The deactivation of the cruise control system does not need to take place at the same point in time as the notification of the driver. Rather, the haptic warning may take place in advance, in order to alert or warn the driver in a timely manner.

One advantageous embodiment of the present invention is characterized in that the deactivation of the cruise control system takes place temporally after the output of the driver warning. Due to a timely alert regarding the impending deactivation, it is ensured that the driver is not surprised, and the driver may adjust to the impending return of the full speed control over the vehicle by him/herself.

One advantageous embodiment of the present invention is characterized in that the haptic signal is a driver-independent brake jolt or a brief brake pulse on the front wheel and/or on the rear wheel.

One advantageous embodiment of the present invention is characterized in that the cruise control system is an ACC system. The ACC is an “adaptive cruise control” system, which is in the area of two-track motor vehicles and may be adapted and transferred to single-track motor vehicles.

One advantageous embodiment of the present invention is characterized in that the single-track motor vehicle is a motorcycle.

One advantageous embodiment of the present invention is characterized in that a visual or acoustic driver warning takes place in addition to the haptic signal.

In addition, the present invention includes a device which includes an arrangement designed for carrying out the above-stressed methods. The device is a control unit, in particular, in which the program code for carrying out the method according to the present invention is stored.

### BRIEF DESCRIPTION OF THE DRAWING

FIG. 1 shows the basic sequence of an example method according to the present invention.

### DETAILED DESCRIPTION OF EXAMPLE EMBODIMENTS

The application of cruise control systems or distance control systems in two-wheelers includes the particularity that a braking operation carried out automatically within the scope of these systems should not take place up to the point of standstill, in order to avoid the situation in which the two-wheeler tips over. For this reason, the system is switched off when a limiting value for the speed is undershot. It is necessary, however, that the driver be informed that the system has been switched off. A piece of visual information in the cockpit of the two-wheeler is suitable only under certain conditions, since the driver possibly does not gaze there frequently enough. An acoustic warning may be easily missed, however. For this reason, the warning with the aid of a brief, slight brake pulse is the most reliable. The brake pulse is configured in such a way, in this case, that a dangerous situation for the driver does not arise. Due to the brake pulse, the driver is also prompted to gaze at the cockpit. For this reason, it is meaningful to also output a piece of visual information there regarding the deactivation of the cruise control system or the distance control system.

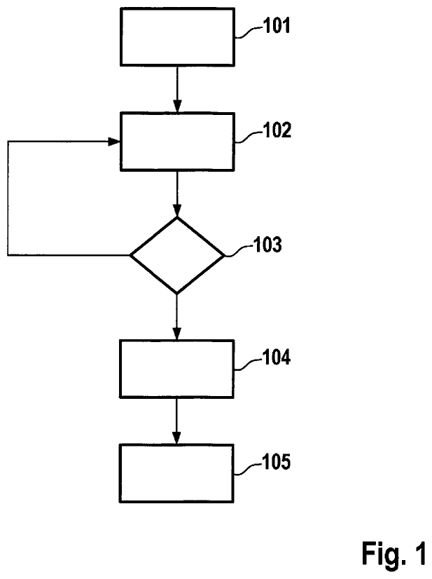

The sequence of an example embodiment of the method according to the present invention is represented in FIG. 1. After the activation of the cruise control function in block 101, the speed of the preceding vehicle is ascertained and adopted in block 102. Finally, in block 103, a check is carried out to determine whether the speed falls below a predefined minimum speed. If this is not the case, the method returns to block 102. If this is the case, however, in block 104, the cruise control system is deactivated, and this is at least haptically communicated to the driver. The method ends in block 105.

1-7. (canceled)

8. A method for influencing a cruise control system of a single-track motor vehicle, comprising:
after activation of the method by a driver of the single-track motor vehicle, ascertaining a speed of a second motor vehicle traveling directly ahead of the single-track motor vehicle;
adopting, by the single-track motor vehicle, the speed of the preceding motor vehicle; and
when a predefined minimum speed is undershot, deactivating the cruise control system and outputting a driver warning regarding the deactivation of the cruise control system using a haptic signal.

9. The method as recited in claim 8, wherein the deactivation of the cruise control system takes place temporally after the output of the driver warning.

10. The method as recited in claim 8, wherein the haptic signal is a driver-independent brake jolt or a brief brake pulse on a front wheel and/or on a rear wheel.

11. The method as recited in claim 8, wherein the cruise control system is an ACC system.

12. The method as recited in claim 8, wherein the single-track motor vehicle is a motorcycle.

13. The method as recited in claim 8, wherein a visual or acoustic driver warning takes place in addition to the haptic signal.

14. A device, comprising:
a control unit configured to influence a cruise control system of a single-track motor vehicle, the control unit configured to:
after activation of the method by a driver of the single-track motor vehicle, ascertain a speed of a second motor vehicle traveling directly ahead of the single-track motor vehicle;
cause the single-track motor vehicle to adopt the speed of the preceding motor vehicle; and
when a predefined minimum speed is undershot, deactivate the cruise control system and output a driver warning regarding the deactivation of the cruise control system using a haptic signal.
